(19) United States
(12) Patent Application Publication
(10) Pub. No.: US 2004/0193456 A1
(43) Pub. Date: Sep. 30, 2004

(54) Out-of-sequence endorsement processing in insurance policy management system

(75) Inventor: John S. Kellington, Cincinnati, OH (US)

Correspondence Address: WOOD, HERRON & EVANS, LLP, 2700 CAREW TOWER, 441 VINE STREET, CINCINNATI, OH, 45202, US

(73) Assignee: The Ohio Casualty Insurance Company, Hamilton, OH

(21) Appl. No.: 10/402,831

(22) Filed: Mar. 28, 2003

(51) Int. Cl. G06F 17/60

(52) U.S. Cl. 705/4

(57) ABSTRACT

An apparatus, program product and method add out-of-sequence endorsements to an insurance policy managed by a policy management system in such a manner that the financial and legal effects of those endorsements are accounted for in an automated fashion. In particular, in response to receiving input data for a new endorsement for an insurance policy that has an effective date that is earlier than at least one existing endorsement applied to the insurance policy, the insurance policy is updated in an automated fashion to rescind the at least one existing endorsement from the insurance policy prior to applying the new endorsement to the insurance policy. Then, after the new endorsement has been applied to the insurance policy, the existing endorsement is then reapplied to the insurance policy.

### CROSS-REFERENCE TO RELATED APPLICATIONS

This application is related to U.S. Ser. No. ______, filed on even date herewith by John S. Kellington and entitled “DYNAMIC PRELOADING OF INSURANCE PRODUCT DATA IN INSURANCE POLICY MANAGEMENT SYSTEM”, which application is incorporated by reference herein.

### FIELD OF THE INVENTION

The invention relates to insurance policy management and computers, computer software and computer systems utilized therefor, and in particular, to the handling of out-of-sequence endorsements to insurance policies.

### BACKGROUND OF THE INVENTION

Insurance policy management systems are among the most complex systems in the information technology industry. A policy management system is typically required to provide the capability for designing unique insurance products (e.g., collision coverage, bodily injury, etc.), as well as to manage the creation of individual policies for customers or policy holders through an issuance process. Created policies must be shipped to customers, and moreover, after issuance and shipping of the policies, functionality must exist for endorsing (changing), cancelling, reinstating, re-issuing, etc. individual policies.

Each policy created in a policy management system is typically custom-built for an individual customer's unique situation. Moreover, at the end of every policy term, e.g., every six months or a year, a renewal policy must be generated that typically incorporates the same coverage, but with different pricing concepts.

The products that may be administered by a policy management system can also vary significantly. Depending upon the particular insurance company involved, the number of potential lines of business, e.g., auto, home, life, general liability, workers compensation, commercial property, inland marine, crime, business, bonds, umbrella, etc., and the various types of coverages that may be offered in those individual lines of businesses, can create a staggering array of policy options. Furthermore, insurance coverage is often subjected to local legislation and rules, necessitating that each state essentially be considered a different market place, with unique insurance products offered in each such state. Furthermore, considering the frequent modifications of coverages and premium costs, each insurance product tends to change on a relatively frequent basis.

Another problematic issue presented by many policy management systems results from the wide variety of users that may be required to access such a system. System administrators, claims adjusters, accountants, and other employees of an insurance company typically require some access to policy data in managing the day-to-day operation of an insurance company. Moreover, insurance agents are required to access the policy management system to serve their customers, including to create new policies or request modifications to existing policies. Some insurance companies employ their own agents; however, others may rely on independent agents that are not employed by the insurance company. The policy management system typically must be capable of handling accesses to customers' policies from all of these entities. Given also that these entities may be widely dispersed from a geographic standpoint, the manner in which these entities can access a policy management system can present significant challenges to IT personnel.

One specific problem facing policy management is that of handling endorsements to customer insurance policies. In particular, an insurance policy is a legal contract between an insurance company and its policy holder. Changing the terms of a policy is thus a non-trivial process from a legal standpoint. Changes to an insurance policy are typically made via “endorsements” to the original agreement between the insurance company and its policy holder. The effect of an endorsement is to modify the coverage provided to a policy holder by the insurance company during the remainder to the term of the policy. As such, an endorsement must have an effective date that specifies when a given level of coverage is in effect. Among other effects, an endorsement may also affect the price of a policy, i.e., the premium paid by a customer to obtain the desired insurance coverage. If an endorsement changes the price of an insurance policy, the endorsement is usually pro-rated for the remainder of the policy term. Moreover, given the nature of an insurance policy as a legal contract, the issuance of an endorsement typically results in the generation of additional papers that are forwarded to the policy holder as a confirmation of the modified terms of the insurance policy.

Endorsements may also have additional effects on a policy management system, including effects on actuarial statistics and general ledger entries for an insurance company. Actuarial statistics are used in financial forecasting for future pricing and coverage, while general ledger entries reflect the financial and accounting data for a company, e.g., used for financial and tax reporting. Therefore, the manner in which endorsements are handled by a policy management system is more involved than a mere update to a policy database.

One particular problematic issue experienced by many policy management systems is that of out-of-sequence endorsements. Given the aforementioned legal and financial implications of endorsements, it is critical that endorsements appear “in sequence,” i.e., having effective dates that occur in the proper sequence. It is not uncommon, however, for endorsements to an insurance policy to be entered into a policy and management system out-of-sequence. For example, an insurance agent may forget to enter an endorsement immediately upon the request for a change by the customer, and may not enter the endorsement until after other endorsements have been applied. Moreover, where multiple individuals have access to a policy management system, one individual may enter an endorsement that effectively becomes out-of-sequence due to the activities of another entity accessing the same policy.

Given that endorsements that affect premiums must be effectively, pro-rated, endorsements must be presented to a policy management system in an appropriate manner to ensure accurate premium calculations.

To date, out-of-sequence endorsements have required manual interaction with a policy management system to ensure that appropriate legal and financial issues are adequately addressed when the endorsements are applied. In particular, to add an out-of-sequence endorsement, a policy typically must be manually rated and statistically coded for the remainder of the term of the policy. As a result, even if subsequent endorsements are “in-sequence” they must still be handled manually. Any instances of out-of-sequence endorsements can therefore cause dramatic work-load and processing efficiency issues for an insurer.

Therefore, given the significant implications of endorsements to insurance policies, a need exists for a manner of simplifying the processing of out-of-sequence endorsements, while ensuring compliance with the legal and financial effects of such endorsements.

### SUMMARY OF THE INVENTION

The invention addresses these and other problems associated with the prior art by providing an apparatus, program product and method in which out-of-sequence endorsements are added to an insurance policy managed by a policy management system in such a manner that the financial and legal effects of those endorsements are accounted for in an automated fashion.

In particular, in response to receiving input data for a new endorsement for an insurance policy that has an effective date that is earlier than at least one existing endorsement applied to the insurance policy, the insurance policy is updated in an automated fashion to rescind the at least one existing endorsement from the insurance policy prior to applying the new endorsement to the insurance policy. Then, after the new endorsement has been applied to the insurance policy, the existing endorsement is then reapplied to the insurance policy.

By effectively “backing out” later existing endorsements prior to applying an out-of-sequence endorsement, and then reapplying those later endorsements, the financial and legal effects of those endorsements to the insurance policy are accurately calculated and maintained, often with little or no involvement by the user that has entered the out-of-sequence endorsement and/or other personnel. As such, greater efficiency and accuracy are typically obtained.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a policy management system incorporating out-of-sequence endorsement processing consistent with the invention.

FIGS. 2A and 2B are timeline diagrams illustrating the addition of an out-of-sequence endorsement to an exemplary insurance policy.

FIG. 3 is a flowchart illustrating the program flow of a process endorsement routine executed by the policy management system of FIG. 1.

FIG. 4 is a block diagram of an exemplary data structure utilized to store an endorsement for an insurance policy using the policy management system of FIG. 1.

FIG. 5 is a flowchart illustrating the program flow of a submit endorsement routine executed by the policy management system of FIG. 1.

FIGS. 6A-6C diagrammatically illustrate updates to exemplary data structures used with the exemplary insurance policy represented in FIGS. 2A-2B, as a result of the processing of an out-of-sequence endorsement in a manner consistent with the invention.

FIG. 7 is a timeline diagram illustrating the result of the addition of the out-of-sequence endorsement to the exemplary insurance policy represented in FIGS. 2A-2B.

### DETAILED DESCRIPTION

The embodiments discussed hereinafter utilize an out-of-sequence endorsement processing routine to efficiently and reliably handle the addition of out-of-sequence endorsements to insurance policies stored and managed in an insurance policy management system. The hereinafter-described routine generally operates by effectively inserting a new endorsement into a sequence of pre-existing endorsements through “backing out” or “undoing” any later-effective existing endorsements to negate the effects of those endorsements on an insurance policy, and then applying the new endorsement and those later endorsements back to the insurance policy in the correct order. Once all such endorsements are applied or reapplied to the insurance policy, the proper ordering of endorsements is obtained, thereby permitting the financial and/or legal effects of those endorsements to be ascertained at any point in time during the term of the policy.

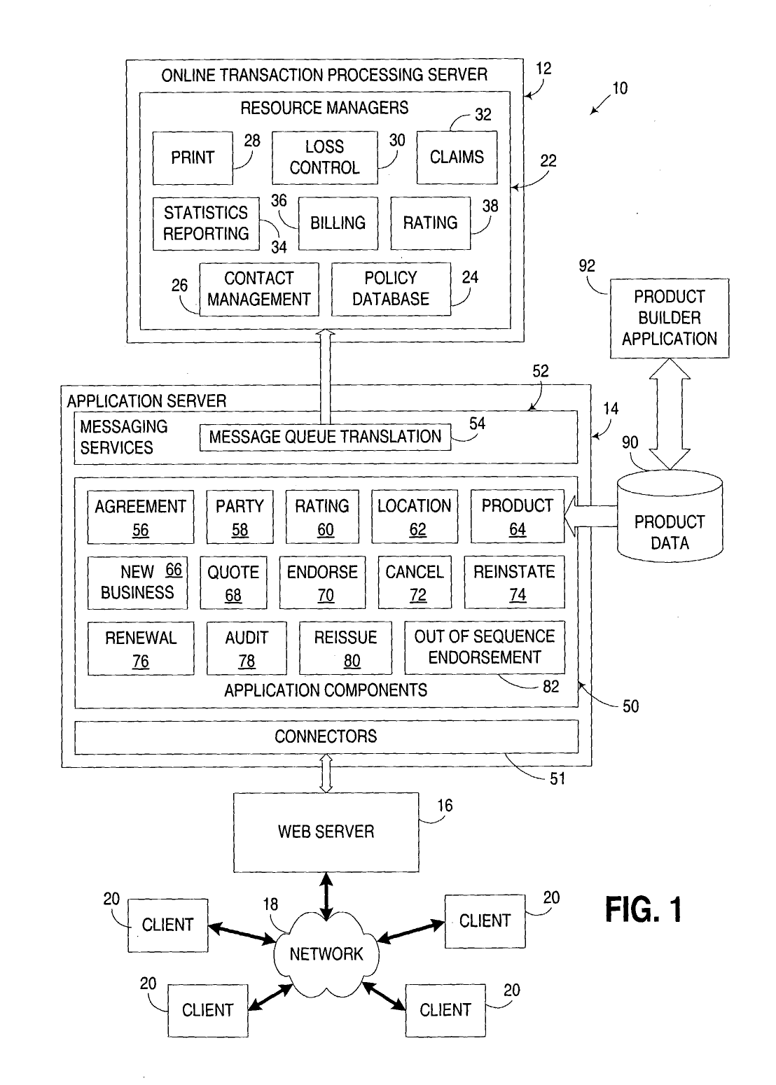

Turning now to the Drawings, wherein like numbers denote like parts throughout the several views, FIG. 1 illustrates an exemplary policy management system 10 incorporating out-of-sequence endorsement processing consistent with the invention. In this implementation, policy management system incorporates a three-tiered structure including an online transaction processing server 12, application server 14 and web server 16 that couples to a network 18 for access thereto by a plurality of clients 20. Each server 12, 14, 16 generically represents, for example, any of a number of different types of multi-user computer systems such as network servers, midrange computers, mainframe computers, etc. Moreover, each server 12, 14, 16 may be implemented using multiple computer systems, e.g., via clustering and other distributed processing techniques. Irrespective of how each server 12, 14, 16 is implemented, however, each such server may individually or collectively be referred to as an “apparatus” hereinafter.

Each server 12, 14, 16 typically includes a central processing unit (CPU) including one or more microprocessors coupled to a memory, which may represent the random access memory (RAM) devices comprising the main storage of the respective server, as well as any supplemental levels of memory, e.g., cache memories, non-volatile or backup memories (e.g., programmable or flash memories), read-only memories, etc. In addition, the memory may be considered to include memory storage physically located elsewhere in the respective server, e.g., any cache memory in a processor, as well as any storage capacity used as a virtual memory, e.g., as stored on a mass storage device or form of external or networked data storage.

Consistent with the herein-described three-tiered architecture, clients 20 access policy management system 10 via web server 16 that is interconnected to the clients via a public network such as the Internet and/or via other forms of networks such as private networks, wired or wireless networks, etc. Clients 20 are typically single-user computers, and are utilized by individual users to access the policy management system. Depending upon the rights granted to particular users, various entities may access a policy management system, including, for example, system administrators, policy holders, insurance company employees, outside agents, etc.

Web server 16 interacts with clients via standard Internet-based protocols such as HTML, Java, etc. to support client access to the policy management system through a standard browser, often eliminating the need to install dedicated software on each client. In other implementations, proprietary installed software may be utilized on the client-side to access a policy management system.

Web server 16 acts as a front-end to the policy management system, and accesses application server 14 to initiate policy management operations and otherwise permit client access to the policy management system. Application server 14 in turn relies upon online transaction processing server 12 to perform back-end and database support. While other online transaction processing server architectures may be used, one suitable architecture for use in a policy management system consistent with the invention is IBM's CICS architecture.

It will be appreciated that the three-tiered architecture described herein is merely exemplary in nature, as other system architectures may be utilized to implement a policy management system consistent with the invention. The invention is therefore not limited to the particular hardware and/or software components described herein.

As will be appreciated by one of ordinary skill in the art, each server 12, 14, 16 operates under the control of an operating system, and executes or otherwise relies upon various computer software applications, components, programs, objects, modules, data structures, etc. to implement the various functions described hereinafter. In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application or software component within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Now turning to the principal software components in policy management system 10, from the standpoint of online transaction processing server 12, a plurality of resource managers 22 are supported, including a policy database manager 24 that manages an insurance policy database that stores relevant information about the various insurance policies being managed by the policy management system. Furthermore, a contact management component 26 manages personnel contacts, i.e., the individuals that may utilize or otherwise be represented in the policy management system, as well as the roles those people play. Additional resource managers may include a print manager 28, a loss control manager 30, a claims manager 32, a statistics reporting manager 34, a billing manager 36 and a rating manager 38. Print manager 28 handles the printout of insurance policies, while loss control manager 30 is utilized to format information for performing surveys. Claims manager 32 handles the claims processing interaction for the policy management system, and statistics reporting manager 34 handles updates to the actuarial statistics and general ledger entries for the enterprise. Billing manager 36 handles billing functionality, while rating manager 38 is utilized in connection with premium calculation.

It will be appreciated that the implementation of the functionality of each of resource managers 24-38 would be apparent to one of ordinary skill in the art having the benefit of the instant disclosure. Moreover, it will be appreciated that other functionality, as well as other combinations of components, may be utilized to implement the online transaction processing or other back-end services provided by server 12. The invention is therefore not limited to the particular implementation illustrated in FIG. 1.

Application server 14 includes a plurality of application components 50, which are accessed by web server 16 via appropriate connectors 51. For example, each application component 50 may be implemented as a JAVA component, with connectors 51 being used to respond to client requests, and format requests for handling by the appropriate processes or domain components. For example, if a client is a Java Applet, a connector may be configured to respond to a Remote Method Invocation (RMI) call and return an RMI call. If a client is an HTML browser, then a connector may be configured to respond to an HTTP post and re-format an RMI call to send to process or domain components. If a client is an agent's management system, then a connector may take the form of a web service.

To access the back-end services provided by server 12, application server 14 also includes a messaging services component 52 including a message queue translation component 54 utilized in issuing transactions for processing by server 12. The access of an online transaction processing server by an application server in this manner is well known to one of ordinary skill in the art having the benefit of the instant disclosure.

Application components 50 provide a number of application services for accessing and otherwise updating policy data stored in the policy management system. As noted above, each component 50 may be implemented using a JAVA component. In the alternative, other programming languages and execution environments may be utilized in application server 14 consistent with the invention.

Among the various application components illustrated in FIG. 1, an agreement component 56 handles updates to policies and coverages, and any other policy information having a legal effect on coverage of an insured. Party component 58 manages people, organizations, and the roles they play. Rating component 60 is utilized in connection with premium calculation, while location component 62 is utilized in connection with defining places, things, and other contact information for locating people.

Product component 64 is utilized to provide product information representing the available coverages and policy options capable of being selected by a customer.

Components 66-82 provide a number of transaction types representing various operations that may be performed against an insurance policy. New business component 66, for example, is utilized in connection with adding a new policy or product offering. Quote component 68 is utilized in connection with providing quotations to potential customers. Endorse component 70 is utilized to apply endorsements to an existing policy, while cancel component 72 is utilized to cancel a policy. Reinstate component 74 is utilized in connection with reinstating a previously-canceled policy, and renewal component 76 is utilized to renew an existing policy. Audit component 78 is utilized to audit an existing policy, while re-issue component 80 is utilized to re-issue a prior policy.

An additional application component relied upon by application server 14 is an out-of-sequence endorsement component 82, which implements the herein-described out-of-sequence endorsement algorithm. Component 82 operates in connection with endorse component 70; however, the allocation of functionality between these two components may vary in different applications. Moreover, the functionality of each of these components may alternatively be incorporated into a single endorsement handler component.

The representation of products, policies and other product- and policy-related information, as well as the implementation of the various components illustrated in servers 12, 14, may be realized in a number different models consistent with the invention. One suitable model, for example, is the Insurance Applications Architecture (IAA) available from International Business Machines Corporation. Other database, transaction processing and/or application server architectures may be utilized in other embodiments consistent with the invention.

In the illustrated embodiment, insurance policies are created from a plurality of products resident in a data structure in application server 14, and managed by product component 64. As is described in greater detail in the aforementioned cross-referenced patent application, the data structure relied upon by product component 64 may be dynamically constructed from information in a product data database 90. By doing so, the overhead associated with accessing the product information for such products is substantially reduced, thereby increasing the workload capacity of the application server.

The product information or data stored in database 90 may be selectively updated by a product builder application 92. Application 92 may be resident on one of servers 12 or 14, or may be resident on a separate computer, and may be used to manage the product data database off line.

The product data database includes product data or information that may be used to create a policy. Practically any information that is relevant to a product offering for a policy management system may be stored in database 90. As will be discussed in greater detail below, for example, product information may be organized into products, roles, and attributes, with name/value pairs utilized to represent all or some of these various entities in the product data database. Products, attributes and/or roles may be assembled together to form product offerings. Multiple product offerings may also be used to construct specifications, which are then collected together to form policies that are suitable for issuing to a customer.

In contrast with many conventional policy management system designs, product information is not encoded into the program code for the policy management system. Rather, a product data database is utilized to provide greater flexibility in terms of product offerings. While use of a product data database would normally provide a bottleneck on system performance in enterprise-wide applications where a large number of users may potentially need to access the product data at the same time, using the preloading or caching functionality described in the aforementioned cross-referenced application, suitable performance is nonetheless realized while maintaining a flexible architecture for updating and otherwise modifying product offerings for the policy management system.

Other details regarding the architecture of policy management system 10 will be apparent to one of ordinary skill in the art having the benefit of the instant disclosure.

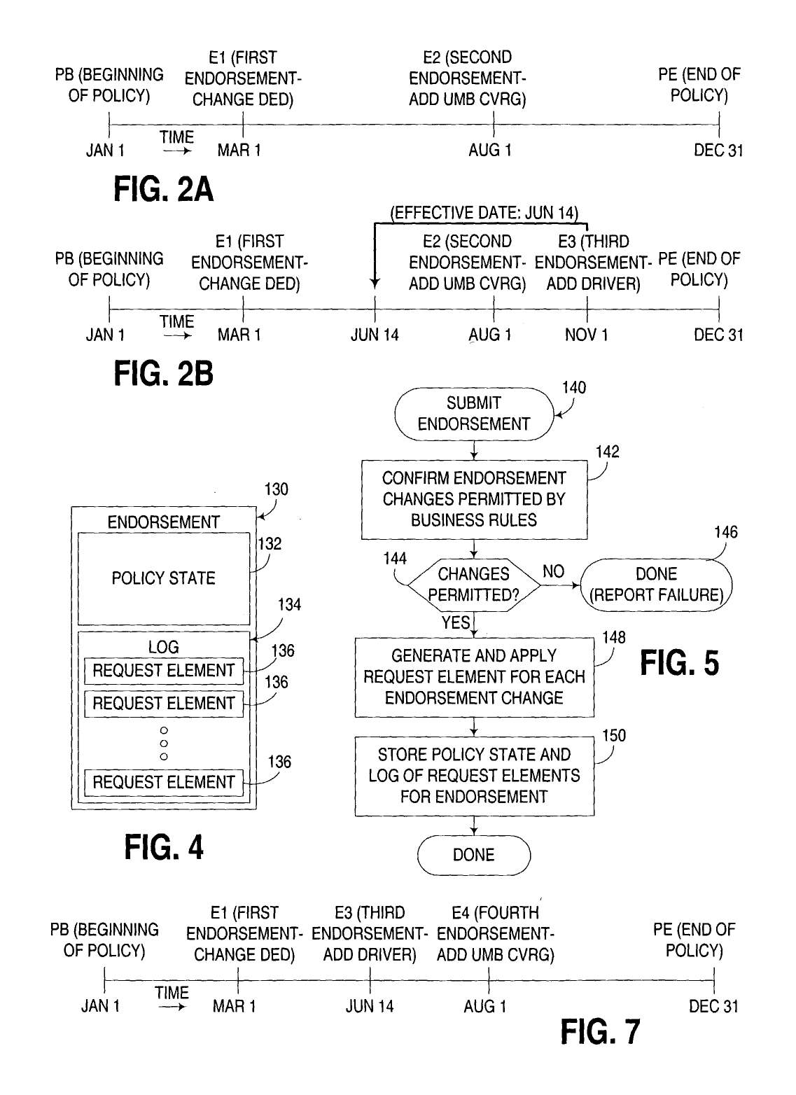

Now turning to FIGS. 2A and 2B, a graphical illustration of the concept of an out-of-sequence endorsement is presented. FIG. 2A, for example, is a timeline illustrating an exemplary auto insurance policy having a one-year term extending from a Policy Beginning date of January 1 to a Policy End date of December 31. Consider that a first endorsement to change the deductible amount is entered as an endorsement E1 having an effective date of March 1. Consider also a second endorsement, which adds umbrella coverage, is entered as an endorsement E2 having an effective date of August 1.

Now turning to FIG. 2B, assume that on November 1, it is determined that a third endorsement needs to be applied, adding a new driver to the insurance policy. This endorsement, denoted as endorsement E3, needs to have an effective date of June 14. For example, it may have been the case that the insurance agent was contacted on June 14 by the customer, but the agent never entered the data into the policy management system at that time. Given, however, that endorsement E2 has already been entered, and has an effective date that is after June 14, endorsement E3 is considered an out-of-sequence endorsement.

Such an out-of-sequence endorsement is handled in policy management system 10, and in particular, utilizing functionality in application components 82 and/or 70, to apply the out-of-sequence endorsement by first effectively “backing out” endorsements applied to the insurance policy having later effective dates than that of an out-of-sequence endorsement. Once the later endorsements are backed out, and effectively undone from the policy, the out-of-sequence endorsement is then applied to the policy. Thereafter, the previously backed out endorsements are re-applied in proper order. The resulting policy data incorporates all endorsements in the proper sequence. Moreover, as will be discussed in greater detail below, any premium adjustments that would have resulted from the proper application of endorsements, are automatically calculated. Furthermore, all actuarial statistics and general ledger entries are updated in the proper manner to ensure compliance with financial and accounting rules.

In the illustrated embodiments, the effective “backing out” of later endorsements is accomplished by retrieving a version of the policy that existed prior to the application of the later endorsements, and submitting one or more negative statistical entries to appropriately account for the reversal of the endorsements in the general ledger and actuarial statistics. Other manners of effectively backing-out an existing endorsement may be envisioned by one of ordinary skill in the art having the benefit of the instant disclosure.

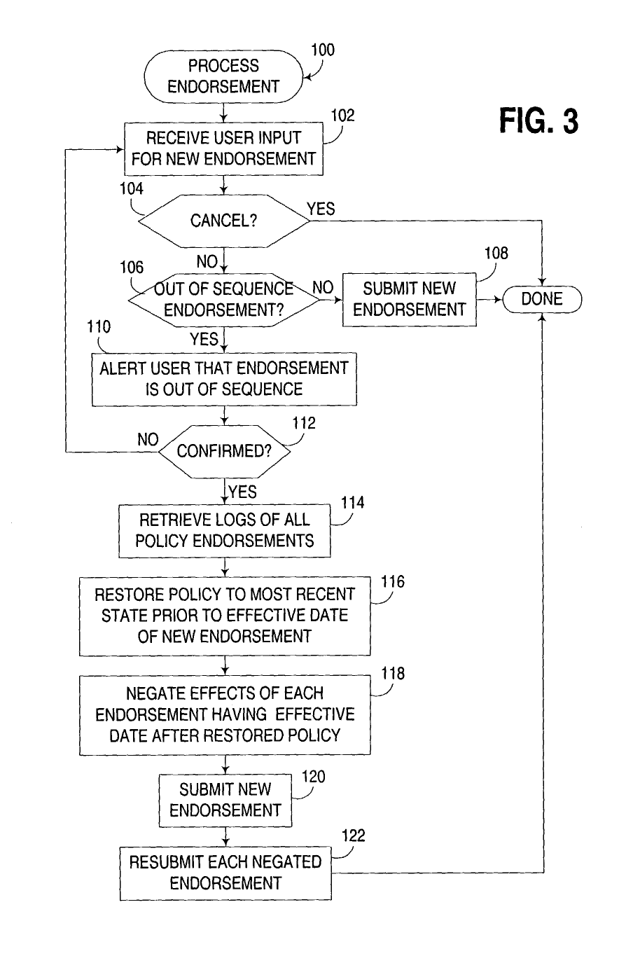

In some embodiments, it may be desirable to process out-of-sequence endorsements in a dedicated manner, and only in response to specific input from a user indicating that an endorsement to be entered is out-of-sequence. In the alternative, it may be desirable to allow a user to attempt to input an endorsement, and utilize the out-of-sequence endorsement handling functionality described herein only when it is detected that an endorsement is in fact out-of-sequence. This latter functionality is utilized in connection with a process endorsement routine 100, illustrated in greater detail in FIG. 3. Routine 100 may be implemented, for example, within endorsement component 70 of FIG. 1, with the out-of-sequence endorsement handling functionality described in the routine implemented directly within component 82 under the overall direction of component 70.

Routine 100 may be executed, for example, in response to user input directed to add an endorsement to a specific insurance policy. Routine 100 begins in block 102 by receiving the user input for the new endorsement. Block 104 then determines whether the user has requested to cancel the endorsement operation. If so, block 104 terminates routine 100.

Otherwise, control passes to block 106 to determine whether the endorsement is out-of-sequence, e.g., by comparing the effective date supplied by the user with the effective date of the last endorsement applied to the insurance policy.

If the endorsement is not an out-of-sequence endorsement, control passes to block 108 to submit the new endorsement to the online transaction processing server to handle the endorsement in a conventional manner. Routine 100 is then complete.

Returning to block 106, if the endorsement is determined to be out-of-sequence, control passes to block 110 to alert the user that the endorsement is out-of-sequence. The user is then prompted in block 112 to confirm that the user wishes to enter the out-of-sequence endorsement. If the user does not confirm as such, control returns to block 102 to receive additional user input for the new endorsement, e.g., to permit the user to modify the effective date such that the endorsement is no longer out-of-sequence. In other embodiments, no confirmation may be sought from the user

Returning to block 112, if the user has confirmed the desire to enter an out-of-sequence endorsement, control passes to block 114 to retrieve the logs of all endorsements applied to the insurance policy at issue.

As shown for example in FIG. 4, an endorsement may be represented by a record 130 including policy state information 132 and log information 134 including a plurality of request elements 136. In the herein-described policy management system, the policy state information stored in an endorsement represents a complete version of the policy at a given point of time, e.g., at the point in time immediately prior to the application of an endorsement, or in the alternative, at a point in time immediately after the endorsement has been applied.

The log information 134 incorporates a detailed listing of each operation that was applied in connection with the associated endorsement. By doing so, future versions of the policy may be constructed by “playing back” the request elements in the log information for the endorsement.

In the illustrated embodiment, it is desirable to utilize a request framework to support the ability to update a policy via a sequence of request elements. Users and programmers, in particular, are desirably unable to update a policy directly. Rather, such entities implement request elements that are submitted to the request framework for processing and updating of the policy information. A request element may include information such as which policy and/or coverage needs to be updated, which coverage to add/delete/modify, and/or the particular data to be modified. A request framework consistent with the invention is capable of modifying a policy and logging the request elements for future use. As such, when an out-of-sequence endorsement occurs, the request framework may be utilized to retrieve all endorsements on a policy, including the logs of request elements, which may then be resubmitted through the request framework to perform the appropriate updates as will be discussed in greater detail below.

It will be appreciated that other frameworks may be utilized to represent endorsements, as well as to perform appropriate updates to policy data. Moreover, it will be appreciated that a wide variety of data structures may be utilized to represent an endorsement consistent with the invention. The invention is therefore not limited to the specific data structure and request framework described herein.

Returning to FIG. 3, and in particular to block 114, the retrieval of the logs of all policy endorsements results in the retrieval of request elements representing the various operations that have been applied to a policy subsequent to its initial creation. As such, when control passes to block 116, it is possible to restore the policy to the most recent state immediately prior to the effective date of a new endorsement. Block 116 may be implemented, for example, by selecting the endorsement (if any) that is immediately prior in time to the effective date of the out-of-sequence endorsement. Then, depending upon whether the policy state for that endorsement represents the state of the policy before or after application of the endorsement, the request elements stored in the log information for that endorsement may be applied to restore the policy state to that which existed as of the effective date as of the new endorsement. If the policy state information for an endorsement, for example, stores the state of the policy after application of an endorsement, then no play back of the request elements associated with that endorsement would be required in block 116.

Next, in block 118, the effects of each endorsement having an effective date after the effective date of the new endorsement are negated. In the illustrated implementation, the effects of an endorsement are negated by applying negated transactions to reverse the actuarial statistics and general ledger entries for each negated endorsement, and to undo, if any, any of the updates to the policy itself. As a result of the execution of block 118, therefore, the policy is effectively in a state that the policy would be in if the later endorsements had never been applied. Typically, the processing of a negated transaction results in the submission of an update request to a financial and/or actuarial computer system that may be internal or external to the policy management system.

The aforementioned request elements, in particular, represent policy change operations to be applied in association with an endorsement. Among these various policy change operations include statistical entries or policy change operations, which are utilized to update financial statistics, e.g., to update a premium for the policy. As will become more apparent below, it is often through the negation of a statistical entry that the effects of a given endorsement can be effectively negated.

It will also be appreciated that negating the effects of a given endorsement may be active and/or passive in nature. In particular, the effects of an endorsement may be effectively negated in part through the retrieval of a policy state associated with an endorsement. In the alternative, changes may be negated through processing of request elements in a reverse fashion. More typically, and as will become more apparent below, it is a combination of restoring the policy state associated with an endorsement, as well as the negation of certain request elements, in particular, statistical entries that update financial information, that the effects of later endorsements are typically negated. Often non-financial effects, such as changes to coverage, deductible limits, selected coverages, etc., will be effectively undone through the restoring of the state of a policy for a date prior to that of any later endorsements. However, given the need to accurately reflect the effective dates of policy changes and the effects those changes have on premium calculations, typically it is desirable to explicitly process negated statistical entries associated with each later endorsement.

Upon completion of block 118, control passes to block 120 to submit the new endorsement, which results in the application of the new endorsement in a generally conventional manner as with any non-out-of-sequence endorsement. Block 122 is thereafter executed to resubmit each negated endorsement, effectively as a new endorsement, thus restoring the endorsements that had been negated in block 118. Routine 100 is then complete.

The submission of a new endorsement in application server 14, and as represented at blocks 108, 118,120 and 122 is implemented by issuing endorsement submissions, e.g., using component 70 of FIG. 1. For example, routine 140 of FIG. 5 illustrates the operations occurring in connection with the submission of an endorsement to an existing insurance policy. Routine 140 begins in block 142 by confirming that the changes associated with a new endorsement are permitted by business rules. In particular, it may be desirable to encode within the product data business rules that limit the combinations of coverages that may be presented on a given insurance policy. For example, product rules might stipulate that no policies with sixteen-year-old drivers are eligible for umbrella coverages. It will be appreciated that these business rules may apply to new endorsements, as well as to endorsements that are reapplied after being negated, when a new out-of-sequence endorsement has been previously applied.

Block 142 passes control to block 144 to determine whether the changes are permitted by the business rules. If not, control passes to block 146 to report a failure to the user, and to terminate routine 140. Otherwise, control passes to block 148 to generate and apply a request element for each change associated with an endorsement. Block 150 then creates a new endorsement record, storing the policy state and log of request elements therefor in the new record. Upon completion of block 150, routine 140 terminates.

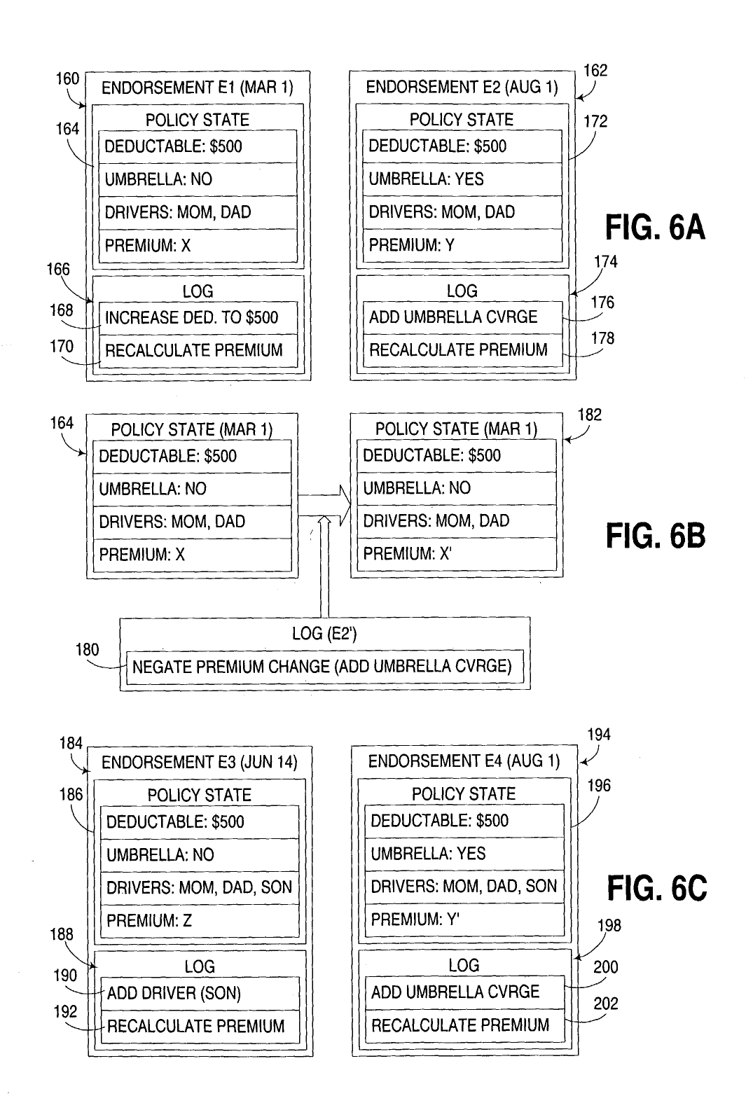

To further illustrate the handling of out-of-sequence endorsements in a manner consistent with the invention, FIG. 6A illustrates a pair of endorsement records 160, 162, representing endorsements E1 and E2 applied to the insurance policy represented in FIG. 2A. Record 160 represents endorsement E1, having an effective date of March 1. The policy state information 164 therefor represents the state of the policy after application of the endorsement. In particular, assume that, as of the effective date of March 1, the policy state has a deductible of $500.00, no umbrella coverage, and two listed drivers, named “Mom” and “Dad.” The premium for the policy as of the effective date is a value represented here at X.

In addition, the log information 166 for record 160 includes request elements 168 and 170. Request element 168 increases the deductible to $500.00, while the request element 170 recalculates the premium to account for the increased deductible.

For endorsement E2, record 162 includes policy state information 172 that represents the state of the policy as of the effective date of August 1. In particular, the deductible value is still $500.00, and the drivers are still listed as “Mom” and “Dad.” However, as a result of the endorsement, umbrella coverage has been added, and a new premium, represented by a value Y, is associated with the policy. As such, the log information 174 includes a pair of request elements 176, 178, with request element 176 adding umbrella coverage, and request element 178 recalculating the premium based upon the addition of umbrella coverage.

It is assumed for the purposes of this example that endorsement E3 shown in FIG. 2B is desired to be applied to the policy with an effective date of June 14, and adding a new driver to the policy, as represented in FIG. 2B. Moreover, it is assumed that this new endorsement is being added as of November 1, i.e., after both endorsements E1 and E2 have previously been entered into the policy management system.

Assume also that a user has input the data for the new endorsement, and has also confirmed that the endorsement, while out-of-sequence, should be entered into the policy. As such, as shown in FIG. 3, block 114 will retrieve logs of all the policy endorsements, here logs 166 and 174, while block 116 will restore the policy to the most recent state prior to the effective date of the new endorsement.

As shown in FIG. 6B, given that the policy state associated with endorsement E1 is the most recent state prior to the effective date of the new endorsement, policy state 164 of record 160 is used to restore the policy to the state as the policy existed as of March 1, i.e., with a deductible of $500.00, no umbrella coverage, “Mom” and “Dad” listed as drivers, and a premium represented at X. Returning briefly to FIG. 3, once the policy is restored to the most recent state, block 118 negates the effects of each endorsement having an effective date after the restored policy. Returning to FIG. 6B, the negation of the effects of later endorsements, here endorsement E2, are represented by the application of a negated premium change transaction 180, which undoes or rescinds the premium change occurring as a result of the addition of umbrella coverage. It will be appreciated that the other request elements in log 174, in particular the addition of umbrella coverage via request element 176, does not need to be reapplied in a negative manner by block 118, as the restore of the policy state to that as it existed as of March 1 effectively undoes the addition of umbrella coverage to the policy.

The submission of the negated premium change transaction 180 in FIG. 6B results in a revised policy state as shown at 182, where the deductible, umbrella and listed drivers information has not changed, but the premium has been modified to that represented by the value X′. Moreover, it will be appreciated that the general ledger entries and actuarial statistics will have been updated to undo the effects of the later endorsement.

Returning again to FIG. 3, once the policy state has been restored and the effects of subsequent endorsements have been negated, the new endorsement is submitted in block 120. As shown in FIG. 6C, this results in the generation of a new endorsement record 184 representative of the new endorsement, here denoted as endorsement E3, having an effective date of June 14. As a result of the application of this endorsement, the policy state information 186 now illustrates a deductible of $500.00, no umbrella coverage, and the addition of a new driver “Son” to the list of drivers to the policy. In addition, the premium is re-calculated to have a value represented at Z. In addition, the log information, represented at 188, includes two request elements, a request element 190 that adds “Son” as a new driver for the policy, and a request element 192 that recalculates the premium based upon the addition of the new driver.

Returning again to FIG. 3, once the new endorsement has been submitted, block 122 re-submits each negated endorsement. As shown in FIG. 6C, for example, the resubmission of the negated endorsement (previous endorsement E2 that added umbrella coverage), has now resulted in the addition of a new endorsement record 194 for an endorsement E4, having an effective date of August 1, and having a policy state wherein umbrella coverage has been added to the policy. In addition, the log information 198 for this new endorsement includes a request element 200 that adds umbrella coverage, along with a request element 202 that re-calculates the premium to reflect the added umbrella coverage. The new premium stored in the policy state information 196 is represented at Y′, representing the premium for the policy as of the effective date of the endorsement (August 1).

FIG. 7 diagrammatically illustrates the result of the out-of-sequence endorsement to the insurance policy of FIGS. 2A and 2B. As may be seen in the figure, the endorsements are properly sequenced to reflect the relative effective dates of each endorsement. Moreover, it will be appreciated that the actuarial statistics and general ledger entries for the policy are effectively updated to maintain proper account and financial records.

It may therefore be seen that the automated functionality described herein may be utilized to properly apply out-of-sequence endorsements to an insurance policy without substantial expertise on the part of the user, and without significant processing overhead. Moreover, financial and accounting records are appropriately maintained in an automated fashion, thus minimizing the possibility for user error.

Other modifications will be apparent to one of ordinary skill in the art having the benefit of the instant disclosure. Therefore, the invention lies in the claims hereinafter appended.

What is claimed is:

1. A computer-implemented method of adding an out-of-sequence endorsement to an insurance policy in a policy management system, wherein the insurance policy includes a plurality of existing endorsements associated therewith, each existing endorsement associated with an effective date and including endorsement data that comprises a policy state representative of a version of the insurance policy as of the effective date and a log of policy change operations applied to the insurance policy as a result of the endorsement, the method comprising:
receiving input data associated with a new endorsement for an insurance policy stored in the policy management system, wherein the endorsement data includes an effective date that is earlier than that of at least one existing endorsement;
restoring the version of the insurance policy to that prior to the effective date of the new endorsement;
negating a statistical entry in the log of policy change operations for an existing endorsement having an effective date that is later than that of the new endorsement;
submitting the negated statistical entry to the policy management system;
updating actuarial statistics and a general ledger in the policy management system in response to submission of the negated statistical entry;
applying the new endorsement to the insurance policy, including creating a policy state and log of policy change operations for the new endorsement;
reapplying the existing endorsement to the insurance policy, including resubmitting the statistical entry to the policy management system.

2. A computer-implemented method of adding an out-of-sequence endorsement to an insurance policy in a policy management system, the method comprising:
receiving input data associated with a new endorsement for an insurance policy stored in the policy management system, wherein the endorsement data includes an effective date that is earlier than that of at least one existing endorsement applied to the insurance policy;
updating the insurance policy stored in the policy management system to rescind the at least one existing endorsement from the insurance policy;
after updating the insurance policy to rescind the at least one existing endorsement, updating the insurance policy to apply the new endorsement to the insurance policy; and
after updating the insurance policy to apply the new endorsement to the insurance policy, updating the insurance policy stored in the policy management system to reapply the at least one existing endorsement to the insurance policy.

3. The method of claim 2, further comprising, after receiving the input data, determining whether the effective date of the new endorsement is earlier than that of the at least one existing endorsement, wherein updating the insurance policy to rescind the at least one existing endorsement, apply the new endorsement and reapply the at least one existing endorsement to the insurance policy are performed only if it is determined that the effective date of the new endorsement is earlier than that of the at least one existing endorsement.

4. The method of claim 3, further comprising, after determining that the effective date of the new endorsement is earlier than that of the at least one existing endorsement, notifying a user that has generated the input data for the new endorsement that the new endorsement is an out-of-sequence endorsement.

5. The method of claim 4, further comprising, after determining that the effective date of the new endorsement is earlier than that of the at least one existing endorsement, prompting the user to confirm that the new endorsement should be applied prior to updating the insurance policy to rescind the at least one existing endorsement, apply the new endorsement and reapply the at least one existing endorsement to the insurance policy.

6. The method of claim 2, wherein each endorsement associated with the insurance policy includes endorsement data that comprises a log of policy change operations associated with such endorsement and a policy state for the insurance policy.

7. The method of claim 6, wherein the policy state for each endorsement identifies a state of the insurance policy after application of the policy change operations identified in the log.

8. The method of claim 6, wherein the policy state for each endorsement identifies a state of the insurance policy prior to application of the policy change operations identified in the log.

9. The method of claim 6, wherein the policy state for each endorsement includes sufficient data to ascertain a complete version of the insurance policy as of a particular date.

10. The method of claim 6, wherein updating the insurance policy to rescind the at least one existing endorsement includes restoring the state of the insurance policy to that which existed prior to application of the at least one existing endorsement and wherein updating the insurance policy stored in the policy management system to reapply the at least one existing endorsement to the insurance policy includes submitting to the policy management system each policy change operation identified in the log associated with the at least one existing endorsement.

11. The method of claim 10, wherein the log of policy change operations associated with the existing endorsement includes at least one statistical entry used to recalculate a premium for the insurance policy, wherein updating the insurance policy to rescind the at least one existing endorsement further includes negating the statistical entry and submitting the negated statistical entry to the policy management system, and wherein updating the insurance policy stored in the policy management system to reapply the at least one existing endorsement to the insurance policy includes resubmitting the statistical entry to the policy management system.

12. The method of claim 11, further comprising updating actuarial statistics and a general ledger in response to submission of the negated and resubmitted statistical entries.

13. The method of claim 6, further comprising automatically generating and mailing revised insurance policy papers to a policy holder after updating the insurance policy to rescind the at least one existing endorsement, apply the new endorsement and reapply the at least one existing endorsement to the insurance policy.

14. The method of claim 6, further comprising, prior to updating the policy to reapply the at least one existing endorsement to the insurance policy includes determining whether reapplication of the at least one existing endorsement is permitted by business rules.

15. An apparatus, comprising:
at least one processor; and
program code configured to be executed by the at least one processor to add an out-of-sequence endorsement to an insurance policy in a policy management system by receiving input data associated with a new endorsement for an insurance policy stored in the policy management system, wherein the endorsement data includes an effective date that is earlier than that of at least one existing endorsement applied to the insurance policy; updating the insurance policy stored in the policy management system to rescind the at least one existing endorsement from the insurance policy; after updating the insurance policy to rescind the at least one existing endorsement, updating the insurance policy to apply the new endorsement to the insurance policy; and, after updating the insurance policy to apply the new endorsement to the insurance policy, updating the insurance policy stored in the policy management system to reapply the at least one existing endorsement to the insurance policy.

16. The apparatus of claim 15, wherein the program code is further configured to, after receiving the input data, determine whether the effective date of the new endorsement is earlier than that of the at least one existing endorsement, and wherein the program code is configured to update the insurance policy to rescind the at least one existing endorsement, apply the new endorsement and reapply the at least one existing endorsement to the insurance policy only if it is determined that the effective date of the new endorsement is earlier than that of the at least one existing endorsement.

17. The apparatus of claim 16, wherein the program code is further configured to, after determining that the effective date of the new endorsement is earlier than that of the at least one existing endorsement, notifying a user that has generated the input data for the new endorsement that the new endorsement is an out-of-sequence endorsement.

18. The apparatus of claim 17, wherein the program code is further configured to, after determining that the effective date of the new endorsement is earlier than that of the at least one existing endorsement, prompt the user to confirm that the new endorsement should be applied prior to updating the insurance policy to rescind the at least one existing endorsement, apply the new endorsement and reapply the at least one existing endorsement to the insurance policy.

19. The apparatus of claim 15, wherein each endorsement associated with the insurance policy includes endorsement data that comprises a log of policy change operations associated with such endorsement and a policy state for the insurance policy.

20. The apparatus of claim 19, wherein the policy state for each endorsement identifies a state of the insurance policy after application of the policy change operations identified in the log.

21. The apparatus of claim 19, wherein the policy state for each endorsement identifies a state of the insurance policy prior to application of the policy change operations identified in the log.

22. The apparatus of claim 19, wherein the policy state for each endorsement includes sufficient data to ascertain a complete version of the insurance policy as of a particular date.

23. The apparatus of claim 19, wherein the program code is configured to update the insurance policy to rescind the at least one existing endorsement by restoring the state of the insurance policy to that which existed prior to application of the at least one existing endorsement, and wherein the program code is configured to update the insurance policy stored in the policy management system to reapply the at least one existing endorsement to the insurance policy by submitting to the policy management system each policy change operation identified in the log associated with the at least one existing endorsement.

24. The apparatus of claim 23, wherein the log of policy change operations associated with the existing endorsement includes at least one statistical entry used to recalculate a premium for the insurance policy, wherein the program code is configured to update the insurance policy to rescind the at least one existing endorsement further by negating the statistical entry and submitting the negated statistical entry to at least one of a financial and an actuarial system, and wherein the program code is configured to update the insurance policy stored in the policy management system to reapply the at least one existing endorsement to the insurance policy by resubmitting the statistical entry.

25. The apparatus of claim 24, wherein the program code is further configured to update actuarial statistics and a general ledger in response to submission of the negated and resubmitted statistical entries.

26. The apparatus of claim 19, wherein the program code is further configured to automatically generate and mail revised insurance policy papers to a policy holder after updating the insurance policy to rescind the at least one existing endorsement, apply the new endorsement and reapply the at least one existing endorsement to the insurance policy.

27. The apparatus of claim 19, wherein the program code is further configured to, prior to updating the policy to reapply the at least one existing endorsement to the insurance policy, determine whether reapplication of the at least one existing endorsement is permitted by business rules.

28. A program product, comprising:
program code configured to add an out-of-sequence endorsement to an insurance policy in a policy management system by receiving input data associated with a new endorsement for an insurance policy stored in the policy management system, wherein the endorsement data includes an effective date that is earlier than that of at least one existing endorsement applied to the insurance policy; updating the insurance policy stored in the policy management system to rescind the at least one existing endorsement from the insurance policy; after updating the insurance policy to rescind the at least one existing endorsement, updating the insurance policy to apply the new endorsement to the insurance policy; and, after updating the insurance policy to apply the new endorsement to the insurance policy, updating the insurance policy stored in the policy management system to reapply the at least one existing endorsement to the insurance policy; and
a signal bearing medium bearing the program code.

29. The program product of claim 28, wherein the signal bearing medium includes at least one of a transmission medium and a recordable medium.
